(19) United States
(12) Patent Application Publication
(10) Pub. No.: US 2008/0033969 A1
(43) Pub. Date: Feb. 7, 2008

(54) Electronic document management method and system

(76) Inventors: Sing Chi Koo, Cupertino, CA (US); Connie L. Chun, Cupertino, CA (US)

Correspondence Address: SING CHI KOO, 10139 MELLO PLACE, CUPERTINO, CA, 95014, US

(21) Appl. No.: 11/642,299

(22) Filed: Dec. 20, 2006

Related U.S. Application Data
(60) Provisional application No. 60/835,832, filed on Aug. 4, 2006.

(51) Int. Cl. G06F 7/00; G06F 17/30; G06F 17/00

(52) U.S. Cl. 707/100; 715/200; 707/1

(57) ABSTRACT

A virtual online document management system wherein an original document is broken down into logical pages before uploading into the document repository in a network environment. Each logical page is converted into a separate electronic image file. Each logical page is an addressable unit within the computer's storage. A virtual document consists of a sequence of pointers to the corresponding logical pages. These virtual documents can also be organized into virtual folders, again by the use of a sequence of pointers. The pointers to the logical pages that designate the virtual documents and the virtual folders are maintained in a computer software program practicing the disclosed method. The user operates on the logical pages with the program to create new virtual documents, retrieve the pages over the network, and to aggregate virtual documents to form virtual folders.

This application claims the benefit of provisional application No. U.S. 60/835,832, filed on Aug. 4, 2006.

### I. BACKGROUND OF THE INVENTION

Modern documents exist in both paper and electronic form. The general trend is to manage all documents electronically. Electronic documents, such as those created by word processing programs, can be stored electronically and can be content searched in their original form. Printed material, handwritten materials, drawings, and other physical or paper documents can be converted into electronic images by scanning and then can be managed electronically. The content of many electronic images can be made searchable through an optical character recognition process. Electronic documents can be viewed as electronic images or may be printed in hardcopy.

The present invention describes a novel method and system for the management of documents that are stored in the form of electronic documents and electronic images.

A. Field Of The Invention

The present invention is in the field of the management of electronic documents and images. Electronic documents include the original output of text-based computer applications, such as word processors and email programs, as well graphical computer programs such as computer assisted design and image editing programs. In addition, document images include documents created by digital imaging devices such as scanners or digital cameras from hardcopy originals.

B. Discussion Of Prior Art

The current invention is a new software management method and system that helps a user preserve the integrity of document assemblages. This is accomplished by organizing electronic documents and images into logical units. This is a novel and useful approach to document management. This new approach differs from methods previously disclosed.

U.S. Pat. No. 5,680,223 describes a method to assign meaningful names for electronic documents so that they can be later retrieved. It is not a method intended for use in manipulating electronic documents.

U.S. Pat. No. 6,988,165 describes a method of how to manage disk space so as to optimize the use of storage devices, not restricted to electronic documents. This methodology offers insight into the management of disk storage potentially that can be used for electronic document images, but does not provide a method for managing electronic documents.

U.S. Pat. No. 6,470,360 offers another method of allocating disk space for database systems. It is not intended for use with managing document pages and aggregating of documents for document management. Although the ability to map pages into contiguous space is essential in document management, this patent does not show how it can be used in conjunction with the management of documents of variable numbers of pages.

U.S. Pat. No. 5,781,785 describes a method for optimizing downloading of document pages for viewing without having to download the entire document. It describes a method of compiling the offset of individual document pages as an index to the content of a multi-page document. The user of the document can simply download the index first and then request just the desired page by submitting the offset of the corresponding page to the server so that the proper page is retrieved without having to download the entire multi-page document. Although the present invention offers the ability to download only a portion of a mult-page document, the fundamental method used to achieve this benefit is distinctively different from the present invention in that document pages are not contiguous, and therefore, the concept of offset is not used as a mean to address document pages. Furthermore, the present invention is a method for the management multiple documents, not just of a single document.

C. Problems With The Prior Art

The prior art method of using offset for identifying a particular page to download may be an effective method of indicating one page in a multi-page document. However, the method only offers a solution to page retrieval in a single document. It offers no solution to the maintenance and modification of a document in such ways as by insertion and deletion. Also, no facility is provided for tracking new revisions of a document. It also does not offer a method for depositing documents into a document repository.

In the prior art, any modification to a document requires the offset of each page to be recompiled and recreated before the document or subsets of the document can be retrieved. Any removal or deletion of pages from a document necessitates the recalculation and recompilation of all the offsets. In the prior art, a document is presented in its entirety without considering the need of a user to manage subsets of a single document. For example, a document often contains multiple pages, and a user may be only interested in a subset of pages within the document. In the prior art, either the document is presented in its entirety or a new document has to be created containing the subset of pages.

Using the offset method of U.S. Pat. No. 5,781,785, the entire offset table is presented to the user. The user then specifies the corresponding offset of the pages of interest, and those pages are then downloaded. However, the specific pages of interest remain as part of the original document. The user has to go through the same process on each request to view specific offsets of pages of interest.

A electronic document can be searchable by machine. The content of such a document can be searched if it is in a character based electronic format, such as a word processing file, or where the electronic image of the document has been processed through an optical character recognition (OCR) process. OCR is performed on electronic document images to extract the machine readable text. This task is process intensive. While prior art methods allow the creation of new documents by aggregating subsets of other electronic documents, the OCR process must be performed again on the new document to make it searchable.

On the other hand, in the current invention, the basic logical unit of a document image can be a single page or a combination of multiple pages. Electronic documents can exist logically in multiple virtual document assemblages, without duplicating the underlying images or OCR files. Therefore, using the method of present invention, the OCR process is done only once, thus eliminating unnecessary processing.

### II. SUMMARY OF THE INVENTION

A common image format is used to store document images of all types in an electronic repository for the management and control of electronic documents. The present invention relies on a single document image format to store document images in a computer repository. Paper documents and electronic documents are converted into electronic image files.

This invention draws a distinction between the concept of a physical page and a logical unit. A logical unit is not restricted to the physical size of the page. Rather, it is a constraint based on the content. As an example, an agreement may consist of several physical pages. In practice, when a logical unit is longer than a physical page, the signer of an agreement is often asked to initial each page so as to confirm the physical continuity of the logical unit. Ideally speaking, for a document consisting of 200 lines, the integrity is preserved if there is a page that can accommodate all 200 lines in a single page. In real life, the 200 lines would generally occupy three physical letter-size pages (8.5″×11″).

In the current invention, we introduce the concept of the logical unit versus the physical page. One example is keeping a multi-page agreement as a single logical unit. In other instances, such as a publication, a book or a journal, the entire volume is viewed by the reader as a document compilation of physical pages. Depending on the interest of the audience, a book may be further subdivided into smaller publications. For example, a librarian would like to treat the table of contents as a separate document that describes the content of the book, whereas a researcher may want to look at the index to abstract the content of the book. It is conceivable that a large compilation such as an anthology may often need to be broken down into smaller documents.

The current invention uses a concept of logical unit spooling to create a repository of logical units for documents. A serial number is assigned to each logical unit so that each logical unit is addressable. Logical documents can then be created from this spool of addressable logical units by maintaining an index to the corresponding logical units by means of the serial number or identifying the serial number. Related documents can be further grouped or aggregated into virtual folders so that a logical view of the document is achieved.

An advantage of maintaining documents in this manner is the elimination of redundant pages when the same page may exist in more than one document.

Another advantage is to eliminate the need to perform redundant OCR on the same page when the same page participates in more than one document.

The third advantage of the invention is to enhance the user experience by providing a uniform speed for a client to view the document over a network regardless of the size of the document. The client can examine the document one page at a time; and the server can serve up the page on demand, eliminating the need to download the entire document before one can view the first page.

The logical document management method allows page insertion and deletion by maintaining the list of the serial number that corresponds to each logical unit of a document.

Another aspect of this invention is to provide a visual feedback to the user as a means to assist the user in maintaining the list of logical units of documents in a folder by abstracting each logical unit into a thumbnail. A multiple page document can be abstracted to display on windows allowing the user to re-arrange the insert and deletion of logical document pages.

Another aspect of the invention is to enable a distributive upload of documents into the repository as logical units. The user can present logical units to the system in a combination of image files, JPG, or multi-page TIF and create a logical document as part of the upload process. Distributive upload procedures enable the user to upload part of a document and incorporate it into a larger document. For example, as each quarterly report is available, it is uploaded as logical document pages to merge into the annual report. The logical unit for the up-to-date report can be updated to reflect the aggregate of logically page from the beginning of the year until present.

A. Short Description Of The Invention

The current invention involves the management of paper and electronic documents. In the method of the invention, a document is made up of logical units. A logical unit can be a single physical page, or it can be an aggregate of multiple physical pages. As a document is input into the system, it is broken down into logical units as defined in the document source.

A database is used to store the metadata of each logical unit. Metadata typically consists of results of OCR or manual coding. The metadata enables one to perform content search to locate the relevant logical units by content.

Each document page in the repository is assigned a unique sequence number. An index database is built on top of the metadata database so that the index database can be used to draw the relationship among document pages. A folder database is established as the container for documents.

By managing the folder database, the meta-data database, and the logical view of folders, documents can be assembled, retrieved, viewed, and organized as needed The advantage of maintaining documents and folders in this matter is:

No redundancy in storing pages that is part of one or multiple documents.

The ability to add or delete pages within a document.

The abilities to combine, merge, and spilt documents by manipulating the folder database, without physically altering or relocating the basic document page.

Multiple logical views can be created by permutation. Since each document page is addressable, user can elect to download or view the pages, one page at a time (without having to download the entire document).

New pages can be inserted or removed from a physical paper document. In electronic document, this is difficult to perform. The present invention provides the mechanism to index the array of pages in a list box, also showing the corresponding thumbnails in an array to correspond to the entries in the list box. One can then perform edit functions such as cut and paste to rearrange the order of the entries in the list box resulting in a new document that bears the new desired sequence of the document.

Automatic upload of text and graphical images to the central Repository

B. Objects and Advantages of the Invention

The notion of using a computer to manage documents is not new. However, there exist no prior art that manages documents similar to the current invention:

None of the prior art describes a procedure for the upload or deposit of electronic documents in a share access environment.

None of the prior art prescribes a procedure to create new documents from subset or superset of documents

None of the prior art offers the notion of virtual document where documents do not exist in the form rendered to the user in a physical form.

None of the prior art offers the notion of logical document where document page are assembled on demand from image pages stored in the archive.

None of prior art offers the notion converting logical document into physical document so that logical document pages can be used to form physical document.

The distinct advantages of the invention are:

Managing multi-page documents by breaking down the pages into addressable logical units.

Providing an automatic procedure where document pages are automatically going through OCR to form an element of a searchable database, where logical unit units are content searchable. For documents consisting of logical document pages, the content is searchable as a contiguous document.

Logical documents can be deposited into folders and the content of the entire folder (containing multiple logical documents) can be searched. Folders can be further grouped by category for taxonomy.

Managing an aggregation of multiple documents in a document folder.

Creating new documents from subsets of existing documents.

Providing the function of re-arranging pages within a logical view and moving images to form a new document. For example, moving the table of contents page from the front to the back to form a new document, removing pages, adding page—a procedure using cut and paste and by rearranging the linear array to create new documents. Also, showing thumbnails as a visual guide for ease of rearranging pages in document.

Prior art focuses on managing multi-page document confined within a document where page images are contiguous. In this invention, a logical document does not have to be stored as contiguous pages within a document.

Establishment of a universal platform consisting of single or multi image page to host output from a variety of sources including handwritten drawing and documents, output from computer applications such as word processor and image software products

Providing distributive document uploading. During the upload process, the system defaults the uploaded document to a logical view in an aggregated update folder. Once upload, the document can be filed in another folder of choice.

Capturing selective document pages into a buffer and generating a PDF containing the captured document pages.

Offering a search engine that performs search across boundaries of logical or physical documents.

Providing the option to display search results showing the search content embedded in context before and after the search key to further narrow the search.

Aggregating pages on demand to create searchable PDF or other searchable character based data files.

### III. BRIEF DESCRIPTION OF THE FIGURES

FIG. 1 is a block diagram of a computer network for providing DOLFIN.

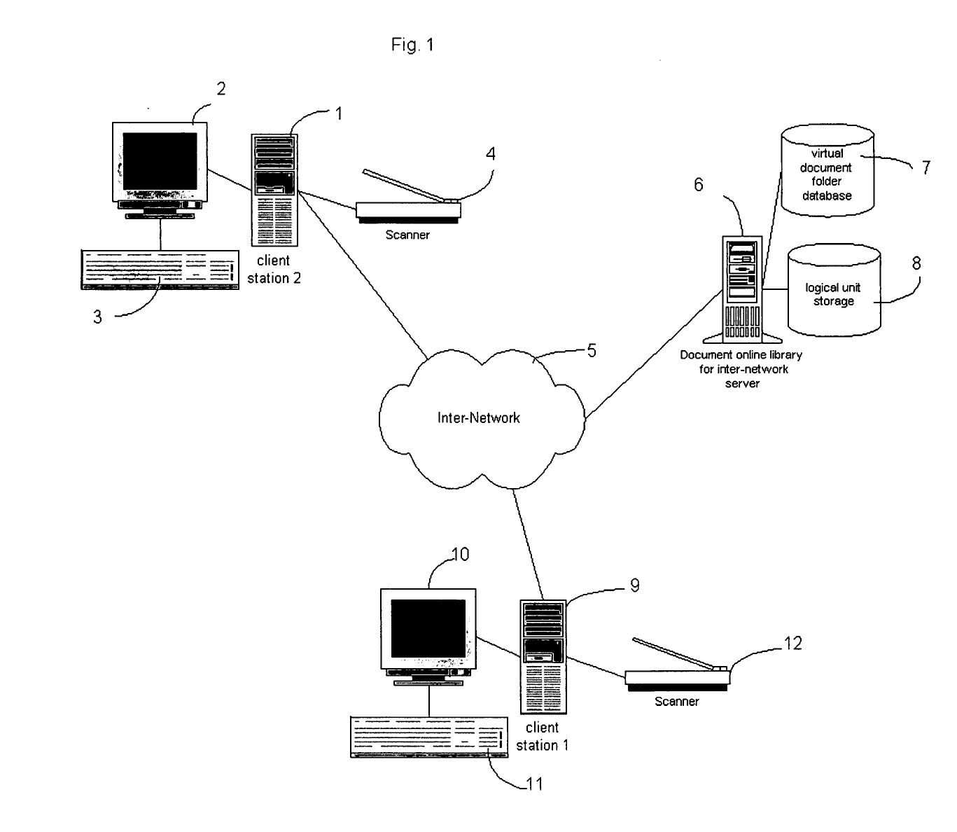

FIG. 2 is a diagram showing the anatomy of a file cabinet.

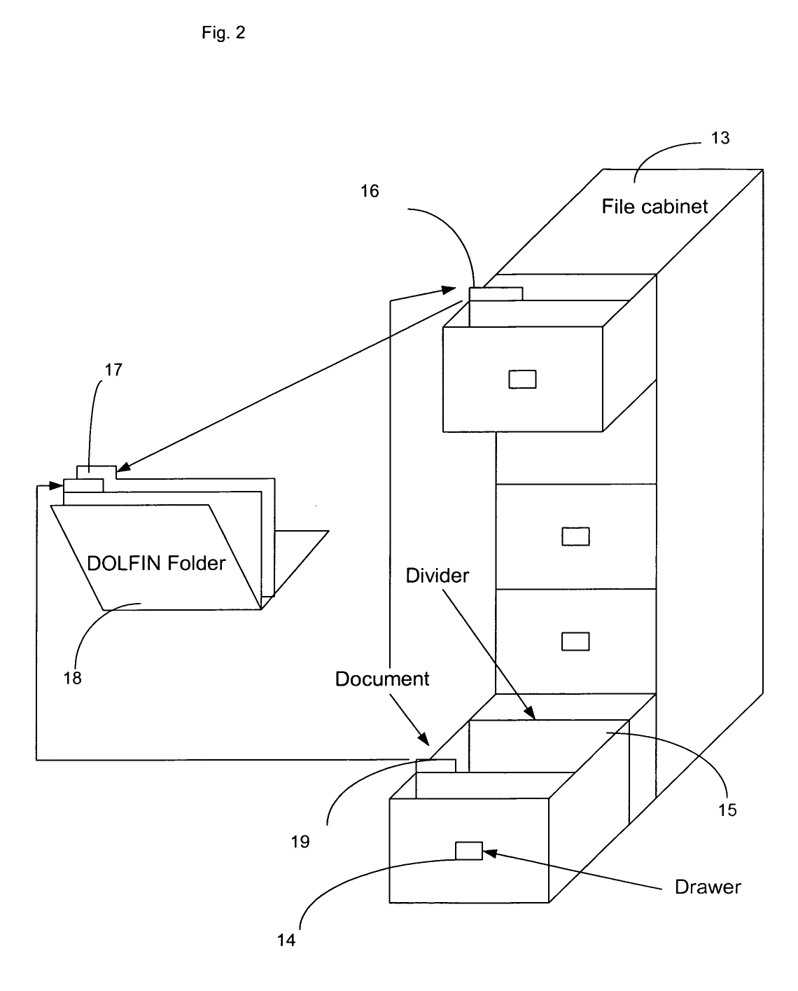

FIG. 3 depicts the relationship between a physical document and the representation of a logical unit in a document.

FIG. 4 shows an upload of a document to DOLFIN and how it is represented internally as two logical units.

FIG. 5 is a diagram showing the relationship between virtual folder, virtual document, and logical units.

FIG. 6 is a flow diagram illustrating a process of the present invention for virtual document folder table.

FIG. 7 is a diagram the thumbnail display of logical units and an edit box for the revision of the page sequence for the logical units 1 to 7.

FIG. 7A is a diagram of the revised order of the logical sequence shown in FIG. 7.

FIG. 8 is a flow diagram illustrating a process of the present invention to upload documents to the system.

FIG. 9 is a flow diagram illustrating a process of the present invention for aggregation of logical units.

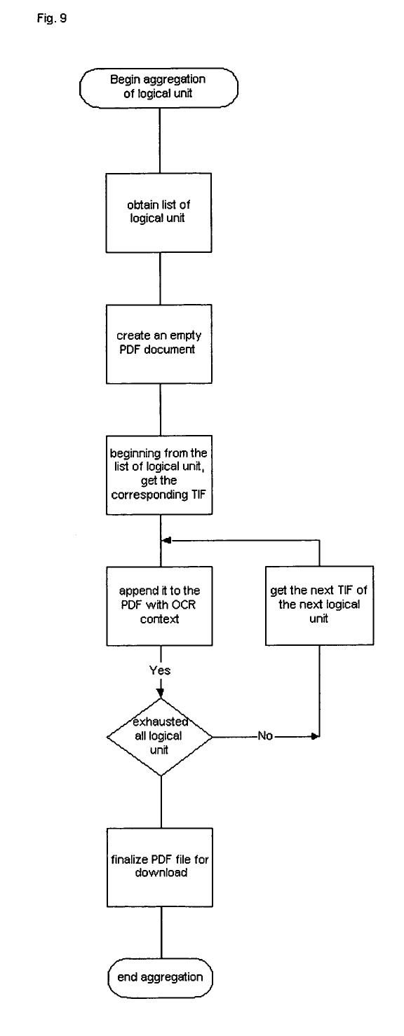

FIG. 10 is a flow diagram illustrating a process of the present invention for creating virtual document.

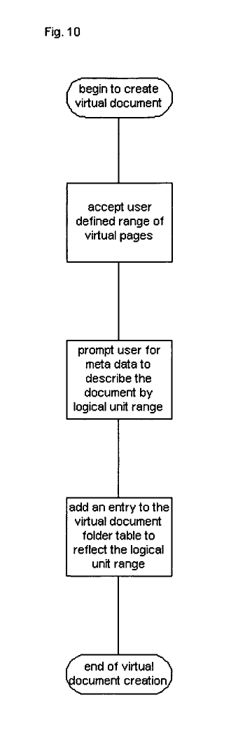

FIG. 11 is a flow diagram illustrating a process of the present invention for viewing pages in virtual documents and virtual folders.

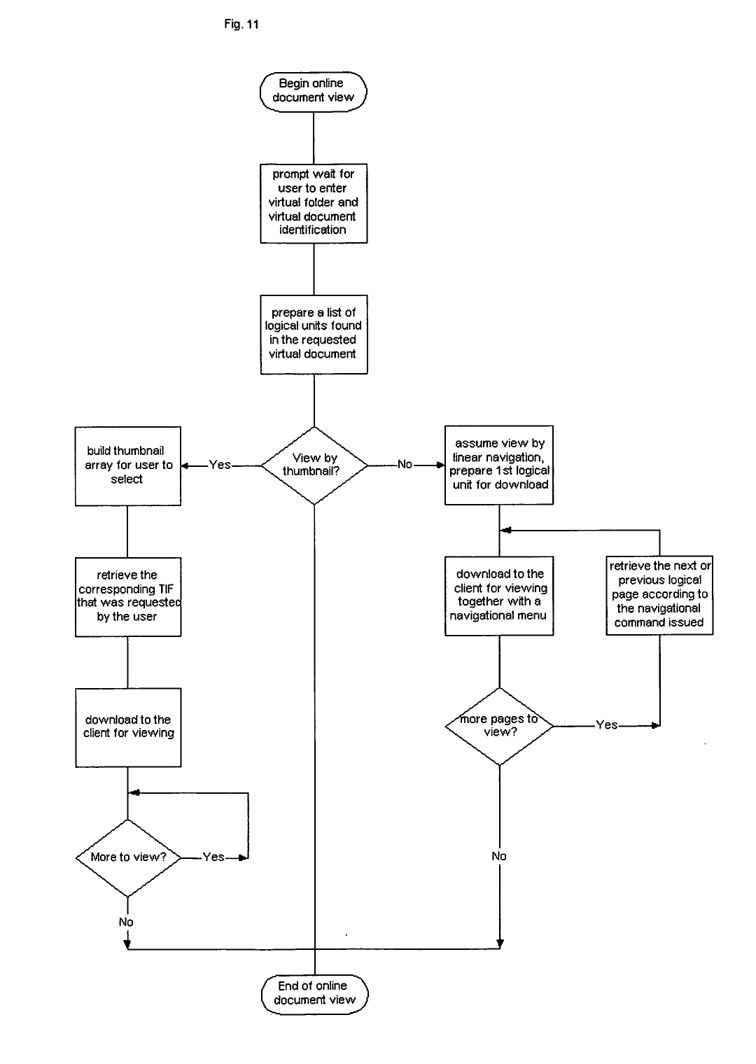

FIG. 12 is a flow diagram illustrating a process of the present invention for making revision to virtual document.

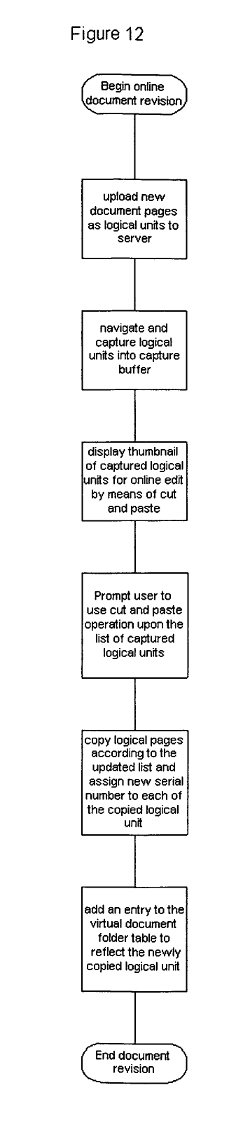

FIG. 13 is a flow diagram illustrating a process of the present invention for searching virtual document for content.

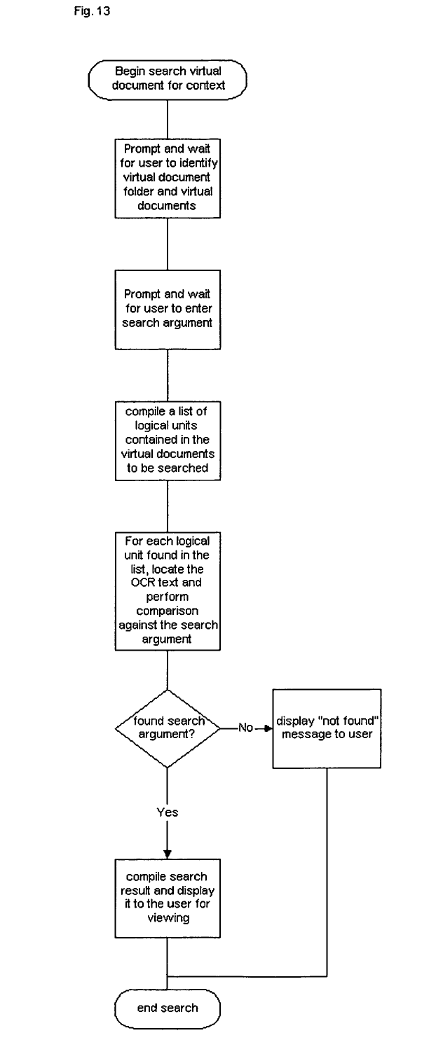

FIG. 14 shows a flow diagram illustrating a process of the present invention of tele-ink.

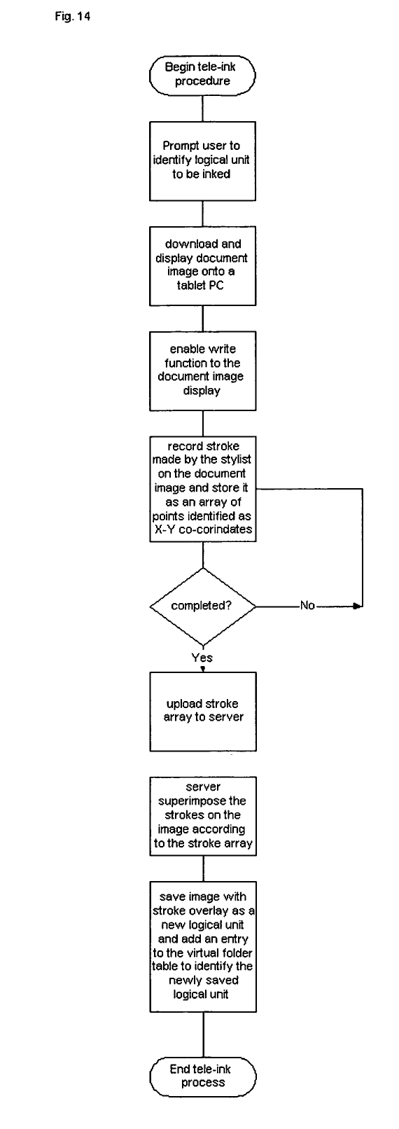

FIG. 15 shows a diagram of functional components making up the current inventions.

FIG. 16 shows how a logical unit is stored in the image pool.

FIG. 17 shows a flow diagram illustrating a process of the present invention associating the workflow to a virtual folder.

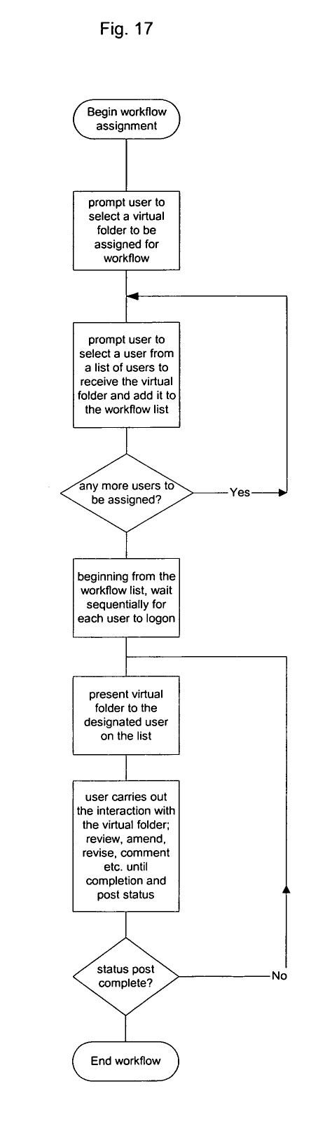

### IV. DETAILED DESCRIPTION OF THE INVENTIONS

The current invention provides a distinct method to manage electronic documents:
Using logical units that may consist of one to many physical pages. Logical units are delimited by the context and content of the physical document, rather than the physical size of a page.
Using logical units and image pools as document storage.
Defining virtual documents as references to ranges of logical units.
Virtual folders contain references of virtual documents.
An image pool is a file storage for logical units. A logical unit is a file in the image pool identified by the image pool identifier and a number assigned in sequential order by the system.
Tele-ink is scribble written on a client workstation over a document image. The scribble is subsequently transmitted to the server, and the server performs the scribble on the document image.
Use of image pool to host logical units
Handling of paper documents using document imaging solutions using logical units and image pools.
Handling of output from computer applications using logical units and image pools.
Document sharing over the network by reference to logical units.
Sign and write over the logical unit using tele-ink.
Add new documents to repository via an upload procedure that converts documents to logical units, virtual documents, and virtual folders.
Retrieve documents and deliver them to client stations via a download procedures, one logical unit at a time.
Enable revision of virtual documents by re-arranging the order of logical units and inserting new logical units.
Enforce document security by tracking access of logical units, to prevent document alternation or modification.
Enable the editing of documents by combining and removing logical units from multiple virtual documents to form a new virtual document.
Enable the editing of virtual documents by providing high-level operations on logical units by copy and paste of virtual document folders and virtual documents.
Convert virtual documents in the repository into PDF for download to the client station by aggregating logical units reference in the virtual document.
All logical units in the repository can be searched by content.
Content search to be applied to a selective group of logical units in a given set of virtual documents only.
Content search to a particular virtual document by logical units.
Grouping virtual documents into virtual folders.
Manage segmented backup of document image pool.
Manage document image pool to enable the adding of new document images and the retrieval of document images.
Enable logical units to be reused in more than one virtual document without having to duplicating the logical units.
Manage the review and audit procedure of documents by means of workflow.

A. Implementation Details

A computer network consists of a server 6 and one or more client workstations 1, 9. A client station has the capability of displaying document images (10,2), a scanner device 4,12 capability of converting paper documents to electronic images, a keyboard and pointing device capable of inputting text and interact with screen display using pointing devices. The computer 1,9 is a general purpose network ready computer capable of running operating systems such as Windows XP. And the operating system is capable of supporting network applications that can send requests and receive responses over the computer network 5 from a remote server 6.

The remote server is a network ready server computer with high-capacity disk storage for the purpose of storing document images and manages large tables such as those services provided by SQLDBMS. In order to accomplish the above inventions, we introduce the concept of virtual folder and virtual document 18. The word virtual is used to describe folder and document because the physical pages do not need to exist in the computer storage as a contiguous document. Rather, it is assembled on demand.

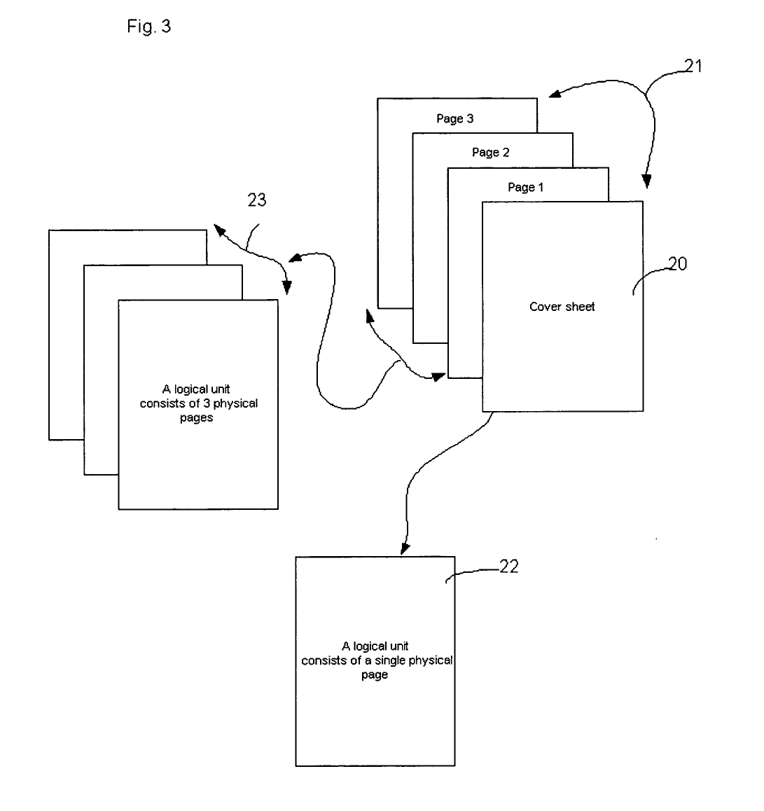

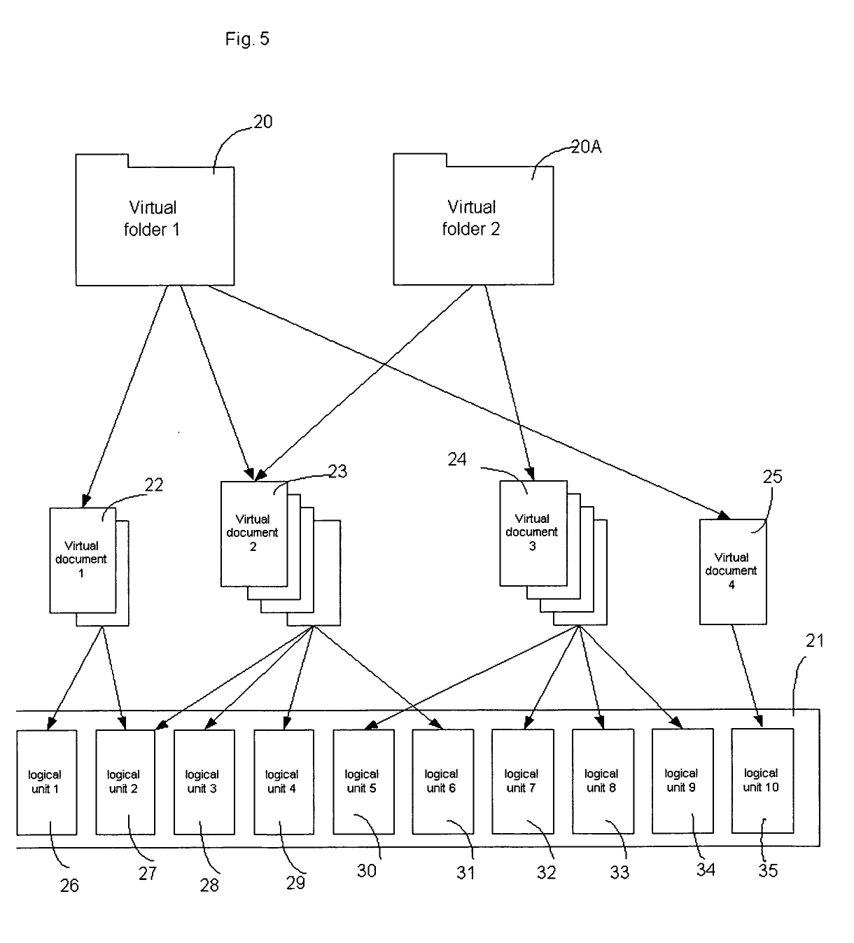

The invention uses a list of indexes as reference points to keep track of pages within a document. The pages are retrieved and assembled on demand. A virtual folder table is used to manage virtual folders and virtual documents. The virtual folder table contains columns to describe folder ID, document meta data, and the range of logical units. (FIG. 5, 6.) A physical page is a single page of paper, typically like 8½ by 11 inches in size, and multiples of such pages make up a physical document. The present invention uses a concept of logical units to manage physical pages in a document. Logical units are not limited by size. Instead, they are delimited by the context or content within the document page. (FIG. 3) A logical unit can accommodate a single page to a multitude of pages. 20, 21.

The basic addressable unit in the document management system is the logical unit. One example of logical unit is an agreement. When an agreement is consists of three physical pages, it is a unified body of terms that should not be separated. If the agreement is to be attached as exhibit or appendix to other documents, the entire 3 pages should be attached. Therefore, the entire agreement of 3 pages should be maintained as a single logical unit. For this reason, a single logical unit will be used to store the 3 pages. Whereas, a cover sheet for a fax transmittal contains only a single page, it is stored as a logical unit by itself (FIG. 3).

In the current invention, logical units are stored in an image pool 21 (FIG. 5). An image pool is defined as a container to host physical pages. An image pool is implemented as a directory in the operating file system that enables the storage of one image file per logical unit. The system uses a text database to store the result text obtained by performing optical character recognition on each logical unit. OCR text records are corresponded to logical units in the image pool.

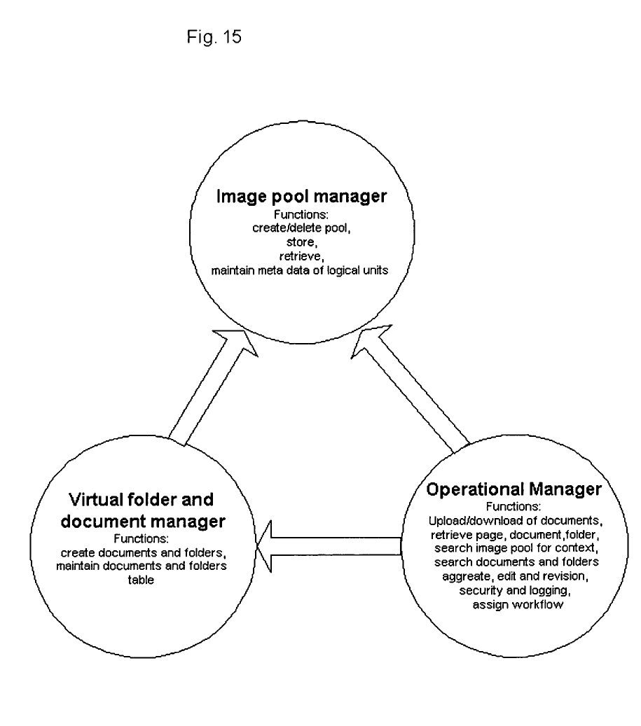

For the purpose of backup and restore, the invention uses multiple image pools to store incoming document pages. By segmenting documents according to document attributes such as time and date, subject domain, etc., the system can use these attributes as criteria to decide in which image pool the incoming document pages should be stored. (FIG. 15, 16)

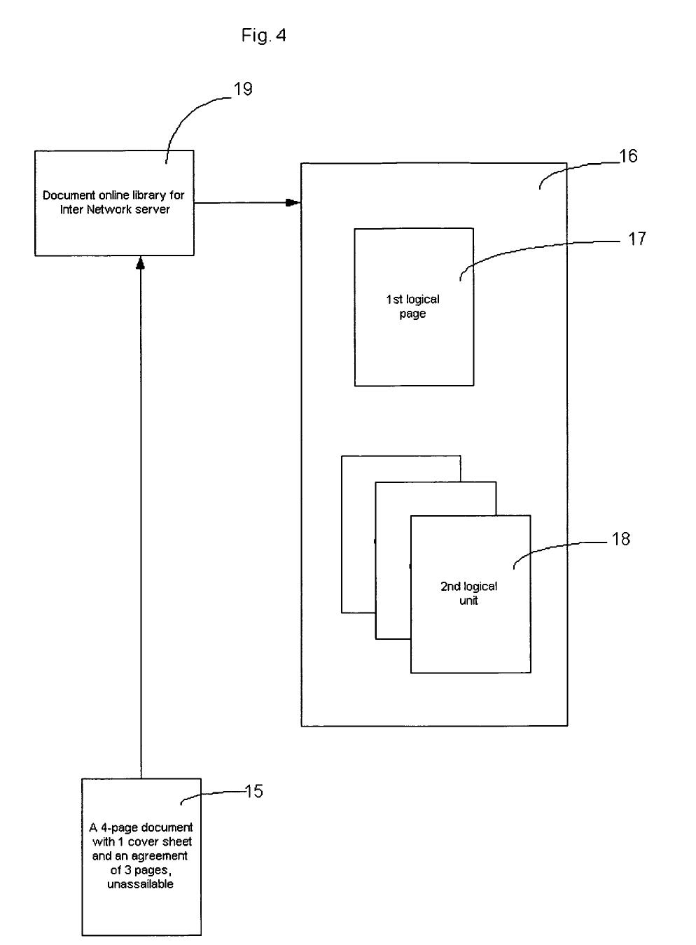

When a document is prepared for import to the document repository, the owner of the document can determine the separation of logical units by converting the document into single page TIF or multi-page TIF. Multiple TIF files are grouped together into a single archive file for the purpose of upload to the system (FIG. 4). Alternatively, if the document page is a picture, JPG format is used. Each TIF or JPG file will be received by the system as a logical unit and will be stored in the assigned image pool as such.

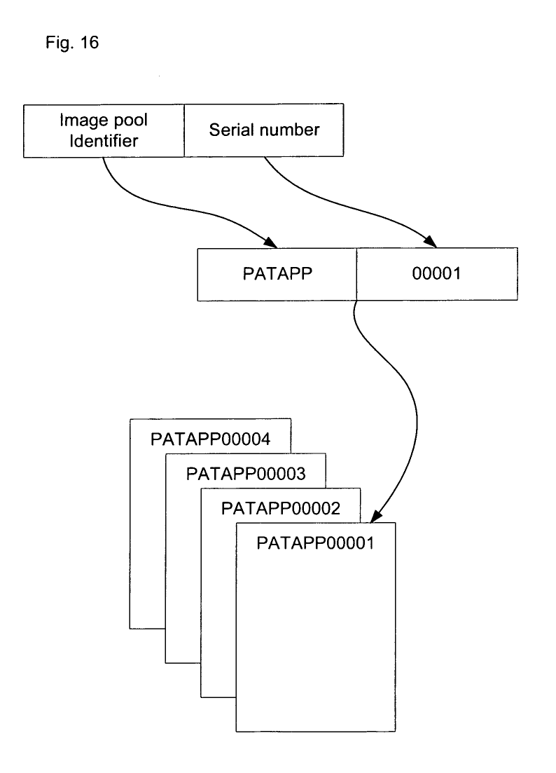

Each logical document is assigned a unique key within the repository so that it can be used as a unique reference or address to the logical unit. The unique key is made up of 2 parts—an image pool identifier uniquely identifies the specific image pool and a serial number that is generated in sequential order (FIG. 16).

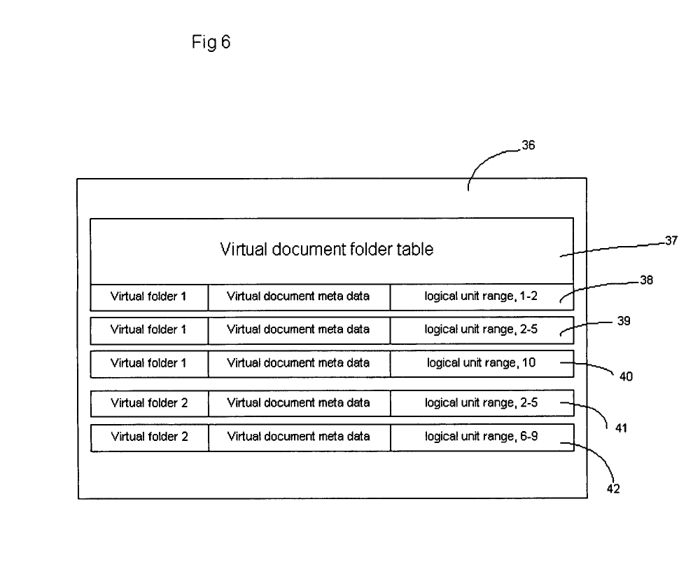

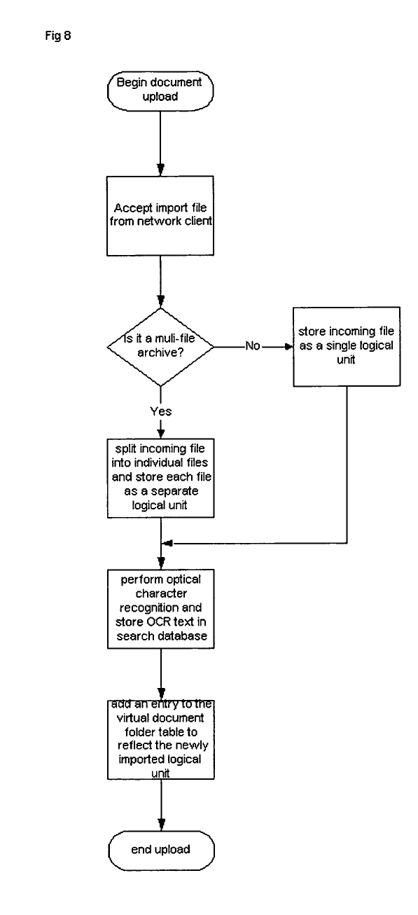

Each document is received by the system as a range of logical units by means of an upload procedure. The upload procedure is a process used to transmit the file from the network client station to the server. When the server receives the document file, the server will break down the incoming document file into logical units. By adding an entry into the virtual folder and identifying the range of logical units, the document will be referenced by the system as virtual documents within a virtual folder (FIG. 6) (flow diagram FIG. 8).

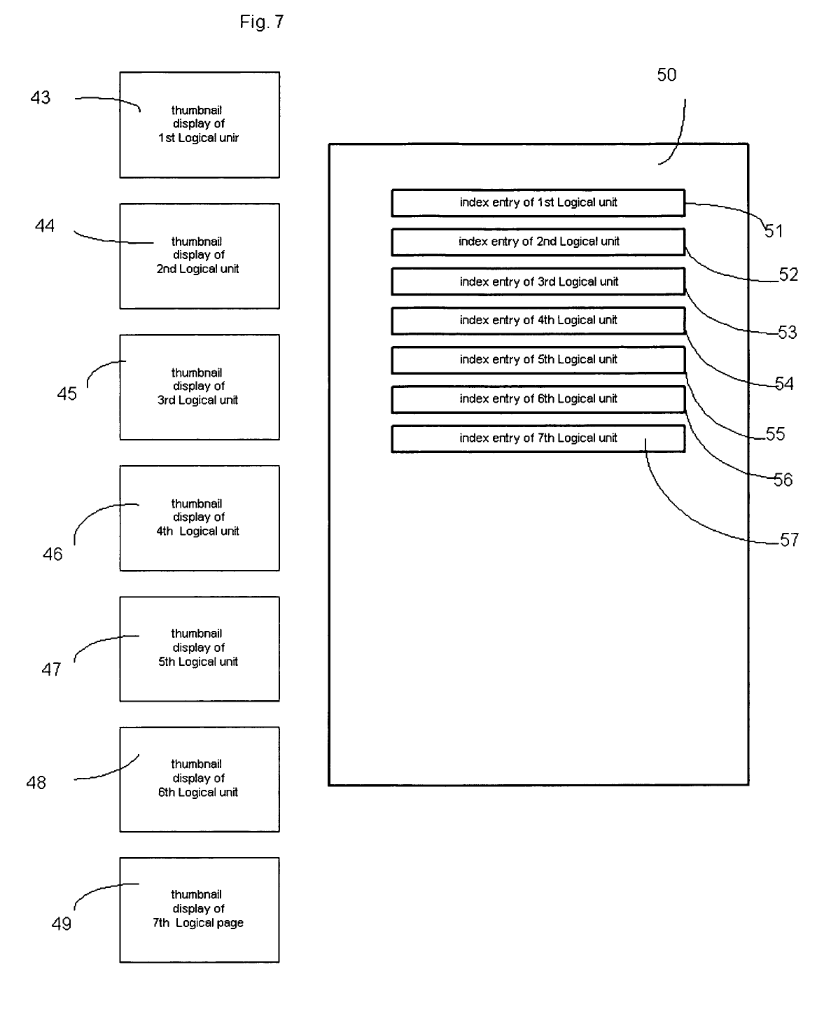

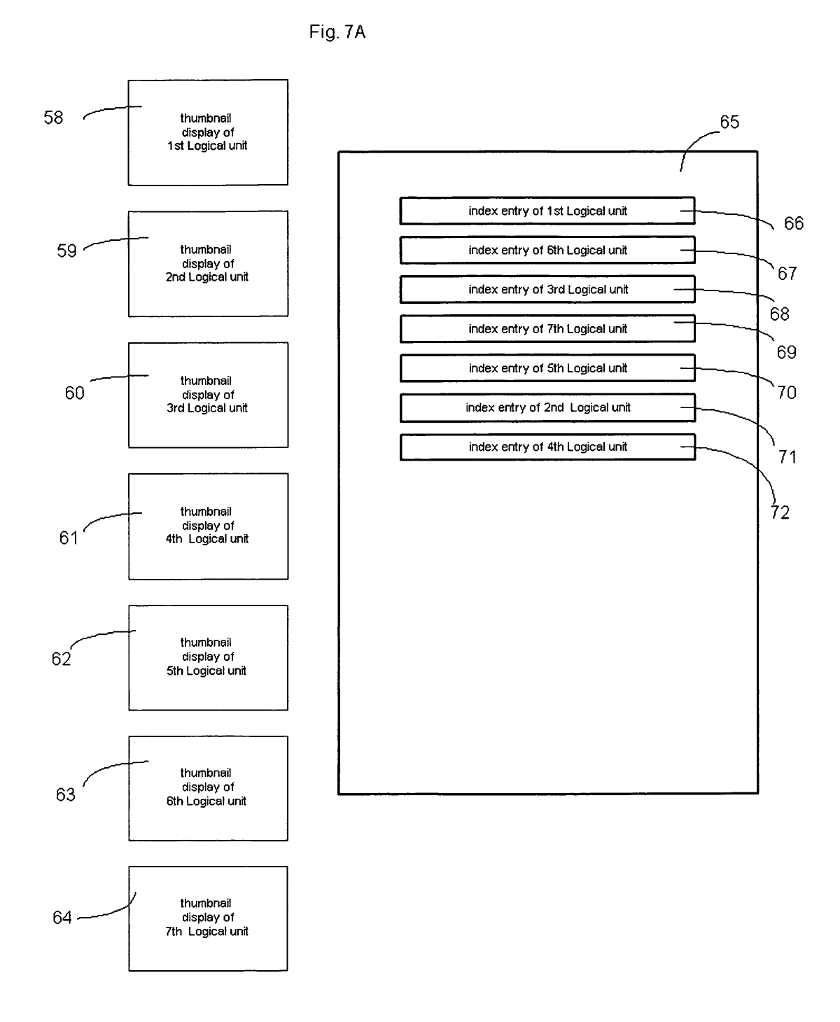

A copy and paste procedure is provided by the system to enable selective copying of virtual documents and virtual folders into a copy buffer and subsequently paste it into another virtual folder (FIG. 7). Alternatively, logical units can be captured into a capture buffer. After all pages are captured, a visual dialogue box together with a thumbnail display showing the abstraction of the logical units is provided to the user for edit and acceptance (FIG. 7A). Logical units can be added, deleted, and re-arranged by means of drag and drop, or cut and paste method until the final revision is arrived. (FIG. 7a). The final revision is than added to the image pool as a new virtual document.

When it is necessary to search globally on all logical units within the repository, a context string that is made up of Boolean connectors is used to specify the search criteria. A comparison is made against the OCR text of the all the logical units. All reference to logical units that match to the search criteria will be compiled into a list for subsequence display, aggregation, and retrieval. The inverted index of the virtual document will enable one to locate the virtual document of which the virtual folder that corresponds to the particular logical unit.

Likewise, the system provides a procedure to search within a single virtual document or a single virtual folder. The procedure involves the compilation of the logical units by virtual document or virtual folder and performs context search similar to that describe in the above paragraph.

When a virtual document is to be retrieved online, pages are downloaded to the client station one logical unit at a time. The system obtains a list of logical units from the virtual document entry in the virtual folder table. The list is presented to the user either in a text list format or in a thumbnail abstraction format. The user can view the pages by selecting it from the list or thumbnail abstraction. This method provides a constant retrieval time for documents of any size since only one logical unit is downloaded to the client station at a time.

In any organization that involves interaction of documents among a team of people, it is important for a document management system to provide a seamless solution for the team to interact with information. A virtual folder integrated with a workflow procedure will enable one to pass the virtual folder to team members for review, audit, amendment, and comment. The current invention provides a workflow mechanism that will schedule a virtual folder to be passed to different users for this purpose.

After a virtual folder is assigned sequentially to a list of users, a virtual folder is presented to the users one at a time. Each user performs the necessary task to the virtual folder, and upon acknowledging the completion of the assigned task, the folder is passed to the next user in the workflow sequence until it reaches completion. Along the way, additional assignment can be created and additional helper folder can be created to accomplish the task.

What is claimed is:

1. An online method for organizing, managing, and manipulating documents comprising:
a. Assigning each original page of a document to one or more user-defined logical units;
b. Assigning to each logical unit a plurality of identification means;
c. Creating a virtual document by aggregating the range of logical unit identifier means.

2. The method as in claim 1, further comprising a virtual folder comprising the aggregation of one or more logical documents.

3. The method as in claim 1 wherein the logical unit document numbers are assigned by the method in sequential order.

4. The method as in claim 1, wherein the logical units are delimited by the context and content of the original document.

5. The method as in claim 1, wherein documents are stored as virtual pages in the image pool.

6. The method as in claim 1, further comprising a plurality of virtual folders that may contain reference information pertaining to a plurality of virtual documents.

7. The method as in claim 1, wherein the image pool is used to host logical units.

8. The method as in claim 1, further comprising document sharing over a computer network using reference to logical units.

9. The method as in claim 1, further comprising converting a document to a logical unit prior to uploading it to the image pool.

10. The method as in claim 1, further comprising converting a document to a virtual document prior to uploading it to the image pool.

11. The method as in claim 1, further comprising converting a document to a virtual folder prior to uploading it to the image pool.

12. The method as in claim 1, further comprising retrieval and delivery of logical unit to a user system (client station).

13. The method as in claim 1, wherein virtual documents can be modified by modifying and adding logical units.

14. The method as in claim 1, further comprising tracking an monitoring access to logical units on the method.

15. The method as in claim 1, further comprising combining logical units to form a new virtual document.

16. The method as in claim 1, further comprising removing logical units from multiple virtual documents to form a new virtual document.

17. The method as in claim 1, further comprising editing logical units by copying and pasting from virtual documents.

18. The method as in claim 1, further comprising editing logical units by copying and pasting from virtual folders.

19. The method as in claim 1, further comprising converting virtual documents in the image pool into PDF format by aggregating logical units referenced in the virtual document.

20. The method as in claim 1, wherein logical units can be searched by content.

21. The method as in claim 20, wherein the scope of the content search includes a plurality of virtual documents.

22. The method as in claim 1, further comprising grouping virtual documents into a plurality of virtual folders.

23. The method as in claim 1, further comprising providing image pool backup of documents based on document attributes.

24. The method as in claim 1, wherein logical units can be accessed in a plurality of virtual documents.

25. The method as in claim 1, wherein additional document images can be added to the image pool.

26. The method as in claim 1, wherein document images can be retrieved from the image pool.

27. An online software system implemented on one or more computers for organizing, managing, and manipulating documents comprising:
a. Assigning each original page of a document to one or more user-defined logical units;
b. Assigning to each logical unit a plurality of identification means;
c. Creating a virtual document by aggregating the range of logical unit identifier means.

28. The system as in claim 27, further comprising a virtual folder comprising the aggregation of one or more logical documents.

29. The system as in claim 27 wherein the logical unit document numbers are assigned by the method in sequential order.

30. The system as in claim 27, wherein the logical units are delimited by the context and content of the original document.

31. The system as in claim 27, wherein documents are stored as virtual pages in the image pool.

32. The system as in claim 27, further comprising a plurality of virtual folders that may contain reference information pertaining to a plurality of virtual documents.

33. The system as in claim 27, wherein the image pool is used to host logical units.

34. The system as in claim 27, further comprising document sharing over a computer network using reference to logical units.

35. The system as in claim 27, further comprising converting a document to a logical unit prior to uploading it to the image pool.

36. The system as in claim 27, further comprising converting a document to a virtual document prior to uploading it to the image pool.

37. The system as in claim 27, further comprising converting a document to a virtual folder prior to uploading it to the image pool.

38. The system as in claim 27, further comprising retrieval and delivery of logical unit to a user system (client station).

39. The system as in claim 27, wherein virtual documents can be modified by modifying and adding logical units.

40. The system as in claim 27, further comprising tracking an monitoring access to logical units on the method.

41. The system as in claim 27, further comprising combining logical units to form a new virtual document.

42. The system as in claim 27, further comprising removing logical units from multiple virtual documents to form a new virtual document.

43. The system as in claim 27, further comprising editing logical units by copying and pasting from virtual documents.

44. The system as in claim 27, further comprising editing logical units by copying and pasting from virtual folders.

45. The system as in claim 27, further comprising converting virtual documents in the image pool into PDF format by aggregating logical units referenced in the virtual document.

46. The system as in claim 27, wherein logical units can be searched by content.

47. The system as in claim 46, wherein the scope of the content search includes a plurality of virtual documents.

48. The system as in claim 27, further comprising grouping virtual documents into a plurality of virtual folders.

49. The system as in claim 27, further comprising providing image pool backup of documents based on document attributes.

50. The system as in claim 27, wherein logical units can be accessed in a plurality of virtual documents.

51. The system as in claim 27, wherein additional document images can be added to the image pool.

52. The system as in claim 27, wherein document images can be retrieved from the image pool.
